(19) United States
(12) Patent Application Publication
(10) Pub. No.: US 2006/0147367 A1
(43) Pub. Date: Jul. 6, 2006

(54) Process for the produciton of synthetic magnesium silicate compositons

(76) Inventors: Terrance Temperly, Cheshire (GB); Michael Whiting, Woolton, Liverpool (GB)

Correspondence Address: MEYERTONS, HOOD, KIVLIN, KOWERT & GOETZEL, P.C., 700 LAVACA, SUITE 800, AUSTIN, TX, 78701, US

(21) Appl. No.: 10/539,468

(22) PCT Filed: Dec. 17, 2003
(86) PCT No.: PCT/GB03/05506

§ 371 Date: Feb. 8, 2006

(30) Foreign Application Priority Data
Dec. 20, 2002 (GB) 0229630.9

(51) Int. Cl. C01B 33/24; C01B 33/32

(52) U.S. Cl. 423/331; 423/332

(57) ABSTRACT

A method for the preparation of a synthetic magnesium silicate having a crystal structure similar to natural hectorite, includes the steps of a) forming a precursor slurry, b) subjecting the precursor slurry to a continuous hydrothermal reaction in a pipe reactor at a temperature of from 210° C. to 400° C. and under a pressure of at least 20 10 bar for 10 seconds to 4 hours, and e) washing and filtering to remove water soluble salts formed in the preparation of the precursor slurry. The precursor slurry is not washed and filtered before it is subjected to the continuous hydrothermal reaction.

### BACKGROUND

1. Field of the Invention

This invention is concerned with a process for the production of synthetic magnesium silicate compositions.

2. Description of the Relevant Art

With the name “hectorite” has been ascribed to a natural trioctahedral smectite found at Hector, Calif., USA, This clay is an hydrous magnesium silicate having the ideal composition Si₈Mg₆O₂₀(OH)₄ modified by having a portion of the Mg⁺² and OH ions replaced by Li+ and F− ions.

The synthesis of hydrous magnesium silicates similar to natural hectorite has been described by Granquist and Pollack in “Clays and Clay minerals” Vol. 8 (Proceedings of the 8^{th} National Conference on Clays and Clay Minerals) pages 150-169. In the process described by Granquist, gels of magnesium hydroxide and of silica are produced separately, are washed, are combined and are re-dispersed in water to form a suspension. Lithium hydroxide or lithium fluoride and sodium hydroxide are added to the suspension that is then treated hydrothermally by refluxing it with stirring until a product having a crystal structure similar to that of hectorite is formed.

While Granquist's product has the crystal structure similar to natural hectorite it does not have good rheological properties. Measuring the Bingharn Yield Value of an aqueous dispersion of the substance provides a standard yardstick of rheological properties of a substance. The term Bingharn Yield Value (also known as Bingham Yield Stress, these terms being alternatives for the same property) is referred to in standard works on theology for example in “Rheology Theory and Applications” F. R. Eirich (Acad. Press) Vol. 1 (1956) page 658 and “Colloidal Dispersions” L. K. Fisher(N.Y. Bureau of Standards) 2′^{d} Edition 1953, pages 150-170 and “The Chemistry and Physics of Clays and other Ceramic Materials” 3^{rd} Edition, page 463, A. B. Searle and R. W. Grimshaw.

The Bingham Yield Value may be determined by first obtaining a flow curve relating the shear stress to the rate of shear and then extrapolating the straight line section of the curve to the shear stress axis, the intercept being the Bingham Yield Value. It can conveniently be determined on any viscometer capable of measuring a range of shear rates and shear stresses.

The product of Granquist, when in the form of a dispersion obtained using 2 g silicate and 100 ml tap water, gives a Bingham Yield Value of only about 15 dynes per cm². This is a very low value, inferior to that given by natural hectorite. It also gives a low static gel strength.

Processes for the production of synthetic hydrous magnesium silicate compositions having a crystal structure similar to natural hectorite but having better rheological properties than natural hectorite have been described in GB-A-1054111, GB-A-to1213122 and GB-A-1432770.

The process described in the GB-A-1054111 involves forming a slurry by co-precipitation by slowly combining with heating and agitation in an aqueous medium a constituent providing the magnesium ions with constituents providing the silicon (as silicates), hydroxyl and sodium ions and treating the precipitate hydrothermally to crystallize the synthetic mineral-like clay, washing and dewatering the resulting crystallized product, and drying the product at a temperature up to 450° C. The concentration of the slurry is desirably such that the concentration of the product formed is from 1% to 8% by weight, preferably 4% by weight. The hydrous magnesium silicate contains fluorine and lithium. The clay-like minerals provided have the structural formula:
(Si₈Mg₆₋ₓLiₓO₂₀(OH)_{4-y}F_{y})^{x(-)}.X/nMⁿ⁽⁺⁾
in which x is between 0 and 6, y is from 1 up to but excluding 4, and M is a cation. Li⁺ may be replaced by Na⁺.

The process described in GB-A-1213122 involves precipitating a magnesium silicate by combining an aqueous solution of a water soluble magnesium salt with an aqueous alkaline solution of one or more sodium compounds in the presence of dissolved silicon compound and hydrothermally treating the precipitate under pressure to crystallize the synthetic mineral-like clay, separating the resultant solid and liquid phases, washing the resulting crystallized product, and drying the product. The concentration of the precipitate is preferably not more than 5% by weight. The hydrous magnesium silicate product contains no fluorine, optionally contains lithium and has the general formula:
[Si₈MgₐLi_{b}H_{4+c}O₂₄]^{(12-2a-b-c)-}M^{(12-2a-b-c)+}
where (i) M is a sodium, a lithium or an equivalent of an organic cation, and (ii) the value of a, b, and c is such that either a<6, b>O, c>O, b+c<2, and (a+b+c−6)<2; or a<6, b=O, c,2 and (a+c−6)<2.

The process described in GB-A-1432770 involves the synthesis of an hydrous magnesium silicate having a crystal structure similar to that of hectorite and having the general formula:
[Si₈(MgₐLi_{b}H_{c})O₂₀(OH)_{4-y}F_{y}]^{z-}.zM⁺
wherein a is 4.95 to 5.7, b is from 0 to 1.05, c is from 0 to <2, a+b+c is from >4 to <8, y is from 0 to <4, z=12−2a−b−c, and M is Na⁺ or Li⁺. The process comprises the sequential steps of forming an aqueous suspension of magnesium carbonate, forming a silica precipitate in the aqueous suspension magnesium carbonate, the proportions of magnesium provided by the magnesium carbonate and silica precipitated in the suspension corresponding to that of the formula of the magnesium silicate, maintaining the resulting mixture of magnesium carbonate and silica in the wet state and subjecting it to hydrothermal treatment by heating it in an aqueous medium and in the presence of the remaining constituents of the magnesium silicate in proportions within the ranges specified in the general formula and in the presence of excess dissolved sodium or lithium compound over that required to form the cation of the magnesium silicate until crystal growth occurs and separating the resulting crystalline product. The crystalline material resulting from the hydrothermal treatment is the separated by filtration, washed, and dried at a temperature not exceeding 450° C. The process described in GB-A-1432770 is distinguished from the processes described in GB-A-1054111 and GB-A-1213122 in that, in those processes, the Mg compound and the silica are co-precipitated.

The products of the processes described in the above prior art documents are characterized by providing dispersions, having Bingham Yield Values substantially in excess of any known to be given by natural hectorite dispersions. Some of these products have found widespread use, by virtue of their excellent rheological properties, in many applications, including in paints; cosmetic products; horticulture; shampoos; detergents; disinfectants; toothpastes; paper manufacture, for example as fillers, retention and drainage aids, and in paper coatings; and drilling muds. The products of the above processes are commercially available as dry white powders, such as the products sold by Rockwood Additives Limited, England, under the trademark “LAPONITE” and, when fully dispersed and hydrated in water, the resulting composition is colorless and transparent.

The processes described in GB-A-1432770, GB-A-1054111 and GB-A-1213122 are generally batch processes comprising a number of sequential process steps, including the preparation of a precursor, the hydrothermal treatment of the precursor and the filtering and washing of the product of the hydrothermal treatment. The overall process reaction time is normally well over 11 hours, including the preparation of the precursor, which takes about 4 hours, and the hydrothermal treatment of the precursor, which takes about 6 hours, at a temperature of about 200° C. and under a pressure of about 17 bar. Whilst it is desirable to employ a process with a shorter overall process reaction time, it is known that even small modifications of the composition of the prior art synthetic magnesium silicates, of the formulation of dispersions comprising such silicates, or of the process of their preparation can have significant deleterious effects upon these rheological properties.

It has been proposed in Japanese Patent Application No 06-345419 to provide a process for the production of synthetic silicate that has a structure similar to a 3-oetahedron-type smectite by subjecting a precursor slurry to a continuous hydrothermal reaction in a pipe reactor. The hydrothermal reaction takes place at high temperature, enabling the processing time to be significantly reduced. For example, in worked example 5 the reaction takes place at 340-360° C. and the reaction time is disclosed asi5 minutes: The precursor, slurry is a silicon magnesium complex or silicon-magnesium aluminum complex, prepared by mixing silicic acid with a magnesium salt, such as magnesium chloride, and alkali, such as sodium hydroxide, and then filtering, washing and condensing the product to form the precursor slurry. The filtered, washed and condensed precursor slurry is then mixed with lithium ions and then subjected to a hydrothermal treatment in the pipe reactor to form a synthetic silicate product, which is then dried without further washing and filtering. Though the worked examples provided in the Japanese document indicate that the products produced from the pipe reactor process were better than the products produced in the comparative examples thereof, when the process is repeated employing the precursor materials of the above commercially available synthetic hydrous magnesium silicate materials, the rheological properties of these products are substantially inferior to the theological properties of the commercially available synthetic hydrous magnesium silicate compositions. Furthermore, whilst the Japanese document teaches how the hydrothermal reaction time may be reduced significantly, the preparation of the precursor slurry is by a time consuming batch process.

### SUMMARY

In one aspect, it is an object of the present invention to provide a process that enables preparation of synthetic magnesium silicate compositions by a process that has an overall reaction time shorter than disclosed in any of GB-A-1054111, GB-A-to 1213122 and GB-A-1432770 and that have improved theological properties to the compositions disclosed in Japanese

In another aspect, it is the object of the present invention to provide a process that enables preparation of synthetic magnesium silicate compositions by a process that has an overall reaction time the same as or shorter than disclosed in Japanese Patent Application No 06-345419 and that have improved rheological properties to the compositions disclosed therein, and preferably comparable theological properties to the compositions disclosed in GB-A-1054111, GB-A-to 1213122 and GB-A-1432770.

It is a further object of the present invention to provide a process that, enables preparation of synthetic magnesium silicate compositions by a process that has an overall reaction time shorter than disclosed in Japanese Patent Application No 06-345419 and that have improved rheological properties to the compositions disclosed therein, and preferably comparable theological properties to the compositions disclosed in GB-A-1054111, GB-A-to 1213122 and GB-A-1432770.

### DETAILED DESCRIPTION

In an embodiment method for the preparation of a synthetic magnesium silicate having a crystal structure similar to natural hectorite is provided. The method includes a) forming a precursor slurry, b) subjecting the precursor slurry to a continuous hydrothermal reaction in a pipe reactor at a temperature of from 210° C. to 400° C. and under a pressure of at least 20 bar for 10 seconds to 4 hours, and e) washing and filtering to remove water soluble salts formed in the preparation of the precursor slurry. The precursor slurry is not washed and filtered before it is subjected to said continuous hydrothermal reaction.

By retaining the water soluble salts in the precursor slurry that is treated to the hydrothermal treatment, which is very much against the disclosure and teachings of Japanese Patent Application No 06-345419, the washed and filtered product formed the hydrothermal treatment will demonstrate significantly improved rheological properties. Indeed, the rheological properties of such products may be at least as good as the rheological properties of the current commercial materials.

In one embodiment of the process of the present invention, there is provided a method for the preparation of a synthetic magnesium silicate of the formula:
[Si₈(MgₐLi_{b}H_{c})O₂₀(OH)_{4-y}F_{y}]^{Z-}.zM⁺
wherein a is 4.95 to 5.7, b is from 0 to 1.05, c is from 0 to <2, a+b+c is from 5 to <8, y is from 0 to <4, z=12−2a−b−c, and M is Na⁺ or Li⁺, the process consisting essentially of the following sequential steps:
a) Preparing a precursor slurry by:
   i) forming an aqueous suspension of magnesium carbonate, and
   ii) forming a silica precipitate ha the aqueous suspension magnesium carbonate,
the proportions of magnesium provided by the magnesium carbonate and of silica precipitated in the suspension corresponding to that of the formula of the magnesium silicate,
b) subjecting the precursor slurry formed in step a) to a continuous hydrothermal treatment in a pipe reactor at a temperature of from 210° C. to 400° C. and under a pressure of at least 20 bar for a period of from 10 seconds to 4 hours to form crystals of said synthetic magnesium silicate, and
c) washing and filtering the product formed in step b) to separate water soluble salts from said synthetic magnesium silicate crystals.

In another embodiment of the process of the invention, the process consists essentially of the following sequential steps:
(a) forming an aqueous slurry from
   i) a water-soluble magnesium salt,
   ii) sodium silicate,
   iii) sodium carbonate or sodium hydroxide and
   iv) material delivering lithium and fluoride ions selected from the group consisting of(A) lithium fluoride and (B) a lithium compound in conjunction with hydrofluoric acid, fluosilicic acid, sodium silicofluoride all sodium fluoride, such that in the slurry the following atomic ratios are present Si/F=0.5 to 5.1; Li/Mg=0.1 to 1.0; Si/(Mg+Li)=0.5 to 1.5; Na/Mg+F—Li=1.0 to 2.0
the aqueous slurry being formed by co-precipitation by slowly combining the said magnesium salt and the said sodium silicate and the said sodium carbonate or sodium hydroxide, with heating and agitation, in an aqueous medium which contains the said material or materials delivering the lithium and fluoride ions;
(b) taking the aqueous slurry so formed and, without washing free from soluble salts, hydrothermally treating it in a pipe reactor at a temperature of from 210° C. to 400° C. and under a pressure of at least 20 bar for 1.0 seconds to 4 hours to form synthetic magnesium silicate crystals, and
(c) washing and filtering the product formed in step b) to separate water soluble salts from said synthetic magnesium silicate crystals.

In a third embodiment of the process of the present invention, a process is provided for the preparation of a synthetic magnesium silicate of the formula:
[Si₈(MgₐLi_{b}H_{c})O₂₀(OH)_{4-y}F_{y}]^{Z-}.zM⁺
wherein a is 4.95 to 5.7, b is from 0 to 1.05, c is from 0 to <2, a+b+c is from 5 to <8, y is from 0 to <4, z=12−2a−b−c, and M is Na⁺ or Li⁺, the process consisting essentially of the following sequential steps:
a) precipitating a magnesium silicate having the desired value of “a” in a slurry by combining an aqueous solution of a water soluble magnesium salt with an aqueous alkaline solution of one or more sodium compounds in the presence of dissolved silicon-delivering material, the pH of the alkaline solution being maintained at 8 to 12.5 throughout,
b) without first drying or washing, hydrothermally treating the aqueous slurry formed in a) in a pipe reactor at a temperature of from 210° C. to 400° C. and under a pressure of at least 20 bar for 10 seconds to 4 hours to form synthetic magnesium silicate crystals, and
c) washing and filtering the product formed in step b) to separate water soluble salts from said synthetic magnesium silicate crystals.

In some embodiments, the hydrothermal treatment is conducted in a pipe reactor at a temperature of from 240° C. to 380° C. and at a pressure of at least 30 bar. In other embodiments, the hydrothermal treatment is conducted in a pipe reactor at a temperature of from 250° C. to 350° C. and at a pressure of at least 40 bar. Under these reaction conditions, the reaction time of the hydrothermal treatment is less than 2 hours and less than 30 minutes, respectively. In certain embodiments, the temperature is in the range of from 285° C. to 315° C., the pressure is at least 70 bar and the reaction time is from 10 to 60 seconds.

In some embodiments, the synthetic magnesium silicate crystals are dried under normal atmospheric pressure at a temperature up to 450° C. after they have been washed and filtered.

The preparation of the precursor slurry is preferably a continuous process, and in certain embodiments, the slurry so produced is fed continuously to the pipe reactor for the hydrothermal treatment. The raw material components may be fed into the pipe reactor at the same time, or they may be stage-fed to add one or more of the raw materials at separate points along the tube reactor.

The preparation of the precursor slurry may also be effected in a pipe reactor. In some embodiments, the temperature of the reaction is from 50° C. up to 400° C. and has a reaction time of less than 3 hours.

In some embodiments, the raw materials used to prepare the precursor slurry comprise sodium carbonate, sodium silicate, magnesium sulfate and lithium carbonate.

In certain embodiments, a pipe reactor is employed for the continuous preparation of both the precursor slurry and for the hydrothermal treatment. This enables a considerable reduction in the overall processing time. For example, the overall reaction time for these two steps may be reduced from 10 hours to well under 3.5 hours, or less.

Pipe reactors are in common use in the chemicals processing industry. The diameter of the pipe reactor can vary, depending upon processing conditions. In certain embodiments, the pipe reactor employed to perform the present invention has a diameter no greater than 20 mm. In some embodiments, the pipe reactor has a diameter no greater than 10 mm. The reaction time will depend upon the actual pipe diameter, length of the pipe, and temperature employed, and these will be readily determined by experimental means by a person skilled in the art. The reactions involved with the preparation of the precursor and/or the hydrothermal treatment may lead to production of gaseous by-products, such as carbon dioxide. Accordingly, the pipe reactor may be vented to enable the gases to be removed. Venting the pipe reactor 30 advantageously enables better e0ntrol of the materials flowing through the reactor.

The product of the process of the present invention retains substantially similar rheological properties to the products formed in GB-A-1054111, GB-A-1213122 and GB-A-1432770. The compositions may be supplied as dry white powders or as moist solids or in dispersions. Accordingly, the compositions may be used in the same type of applications as the prior art products. For example, the compositions may be used in paints; cosmetic products; shampoos; detergents; disinfectants; toothpastes; paper manufacture, for example as fillers, retention and drainage aids, and in paper coatings; and drilling muds.

### EXAMPLES

The following examples illustrate aspects of the invention, but are not in any way intended to limit the scope the invention.

### Example 1

### Preparation of Precursor Slurry (Bulk Preparation)

A measured quantity of lithium carbonate and water (sufficient to dissolve the measured quantity of lithium carbonate) is placed in a flask fitted with a stirrer, a heating mantle and a refluxing condenser. In a separate vessel, a measured quantity of magnesium sulfate is dissolved in sufficient water such that the solution was almost saturated and the solution added to the lithium carbonate solution. The mixture was brought to a temperature of at least 60° C. under reflux while stirring efficiently.

From a separate vessel a measured quantity of sodium carbonate solution is added slowly to the reaction vessel containing the lithium carbonate and magnesium sulfate-solution. The addition is made over a period of up to one hour, while the reaction mixture is kept at 60° C. or greater and stirred efficiently throughout.

From a separate vessel a measured quantity of sodium silicate solution is added slowly to the reaction vessel containing the lithium carbonate, magnesium sulfate and sodium carbonate solution. The addition is made over a period of up to one hour; while the reaction mixture is kept at 60° C. or greater and stirred efficiently throughout.

The mixture is then boiled under reflux, with efficient stirring, for about 2 hours.

### Example 2

### Preparation of Precursor Slurry (Continuous Preparation Mode 1)

A measured quantity of powdered lithium carbonate, magnesium sulfate and sodium carbonate and water at 60° C. is metered into an open-top reactor and stirred vigorously. The amount of water is such that the solution is almost saturated. The reactor is fitted with various baffles and flow control modifiers such that the aqueous reaction mixture is retained in the reactor for up to 1 hour before it passes to an outflow pipe that feeds into a second open-top reactor. As the reaction mixture is metered into the second reactor it contacts a measured quantity of sodium silicate solution that is also being metered into the reactor. The second reactor is fitted with stirrers and various baffles and flow control modifiers such that the aqueous reaction mixture is retained in the second reactor at 60° C. for up to 1 hour before it passes to an outflow pipe that feeds into a third open-top reactor. The third reactor is fitted with stirrers and various baffles and flow control modifiers such that the aqueous reaction mixture is retained in the third reactor at 98° C. for about 2 hours before the final precursor slurry so prepared passes to an outflow pipe that feeds into a holding tank or feeds directly to a pipe reactor for hydrothermal treatment. Any gases that are evolved during the process escape from the top of the reactors,

### Example 3

### Preparation of Precursor Slurry (Continuous Preparation Mode 2)

A measured quantity of powdered lithium carbonate, magnesium sulfate and sodium-carbonate and water at 60° C. is metered into an open-top reactor and stirred vigorously. The amount of water is such that the solution is almost saturated. The reactor is fitted with various baffles and flow control modifiers such that the aqueous reaction mixture is retained in the reactor for up to 1 hour before it passes to an outflow pipe that feeds into a second open-top reactor. As the reaction mixture is metered into the second reactor it contacts a measured quantity of sodium silicate solution that, is also, being metered into the reactor. The second reactor is fitted with stirrers and various baffles and flow control modifiers such that the aqueous reaction mixture is retained in the second reactor at 60° C. for up to 1 hour before it passes to an outflow pipe that feeds directly to a pipe reactor for hydrothermal treatment. Any gases that are evolved during the process escape from the top of the reactors.

### Example 4a

### Preparation of Precursor Slurry (Continuous Preparation Mode 3-5 in a Pipe Reactor)

A measured quantity of powdered lithium carbonate, magnesium sulfate and sodium carbonate and water at 60° C. is metered through individual ports into the starting end of a pipe reactor having a diameter of about 7 mm. The amount of water is such that the solution is almost saturated. The reactor is fitted with various baffles and flow control modifiers such that the aqueous reaction mixture is retained in the reactor for up to 1 hour before it contacts a measured quantity of sodium silicate solution that is also being metered through another port into the reactor. As the mixture passes through the pipe reactor over a period of up to 1 hour, at a temperature of up to 400° C. and any gases that are evolved during the process are vented away through vents located along the pipe. The material obtained at the exit of the reactor is a precursor slurry.

### Example 4b

### Preparation of Precursor Slurry (Continuous Preparation Mode 3—in a Pipe Reactor)

A measured quantity of powdered lithium carbonate, magnesium sulfate, sodium carbonate, sodium silicate and water at 60° C. is metered in tandem into a batch reactor. The amount of water is such that the components in solution are almost saturated. Once the mixture forms an homogenous slurry, i.e. after about two minutes of mixing from when all the components have been added to the batch reactor, the slurry is then metered into the starting end of a pipe reactor having a diameter of about 7 mm. The reactor is fitted with various baffles and flow control modifiers such that the aqueous reaction mixture is retained in the reactor for about 4.6 minutes. As the mixture passes through the pipe reactor the temperature rises to 180° C. for at least 50% of the time the mixture is in the pipe. Any gases that are evolved during the process are vented away through vents located along the pipe. The material obtained at the exit of the reactor is a precursor slurry.

### Examples 5 to 8

### Hydrothermal Treatment

The precursor slurries obtained in each of Examples 1 to 4 are each individually fed into a pipe reactor having a diameter of about 7 ram. The pipe reactor has an internal temperature of 300° C. and pressure of 80 bar. The slurry now undergoes a hydrothermal reaction. The pipe reactor is of such a length that material is retained in the reactor for 20 seconds, before it is ejected from the reactor into a bath where magnesium silicate crystal so formed are wash and filtered to remove soluble salts.

After drying at 190° C. and micronized to particle size of no greater than 20 microns, the theology properties of the powders so produced will be found to have substantially the same rheology properties as currently available commercial synthetic hectorite materials.

### Example 9

### Comparative

The precursor slurry formed in Example 1 was washed and filtered to remove water soluble salts before undergoing a hydrothermal treatment. The theological properties of the synthetic magnesium silicate produced will be found inferior to those same properties of a magnesium silicate prepared by the process of the present invention.

1-36. (canceled)

37. A method for preparing a synthetic magnesium silicate having a crystal structure similar to natural hectorite; the method comprising:
forming a precursor slurry;
subjecting the precursor slurry to a continuous hydrothermal reaction in a pipe reactor at a temperature ranging from 210° C. to 400° C. and under a pressure of at least 20 bar for 10 seconds to 4 hours to form the synthetic magnesium silicate, wherein the precursor slurry is not washed and filtered before it is subjected to the continuous hydrothermal reaction; and
washing and filtering the synthetic magnesium silicate to remove water soluble salts formed in the preparation of the precursor slurry.

38. The method of claim 37, wherein forming the precursor slurry comprises:
forming an aqueous suspension of magnesium carbonate, and forming a silica precipitate in the aqueous magnesium carbonate suspension, the proportions of magnesium provided by the magnesium carbonate and of silica precipitated in the suspension corresponding to the formula of:
[Si₈(MgₐLi_{b}H_{c})O₂₀(OH)_{4-y}F_{y}]z⁻.zM⁺
where a ranges from 4.9 to 5.7; b ranges from 0 to 1.05; c ranges from 0 to less than 2; (a+b+c) ranges from 5 to less than 8;
y ranges from 0 to less than 4; z=12−2a−b−c; and M is Na or Li.

39. The method of claim 37, wherein forming the precursor slurry comprises co-precipitating (a) a water-soluble magnesium salt; (b) sodium silicate; and (c) sodium carbonate or sodium hydroxide with a material capable of delivering lithium ions and fluoride ions such that in the formed precursor slurry the following atomic ratios are present: Si/F is 0.5 to 5.1; Li/Mg is 0.1 to 1.0; Si/(Mg+Li) is 0.5 to 1.5; and Na/(2Mg+F—Li) is 1.0 to 2.0.

40. The method of claim 39, wherein the material comprises lithium fluoride.

41. The method of claim 39, wherein the material comprises a lithium compound in conjunction with hydrofluoric acid, fluosilicic acid, or sodium silicofluoride all sodium fluoride.

42. The method of claim 39, wherein co-precipitation is performed with agitation and at a temperature of at least 60° C.

43. The method of claim 39, wherein the co-precipitation comprises:
(a) adding the water-soluble magnesium to the lithium and fluoride ions delivering material;
(b) adding the sodium carbonate or sodium hydroxide solution to the solution formed in (a); and
(c) adding the sodium silicate to the solution formed in (b).

44. The method of claim 37, wherein the synthetic magnesium silicate has the formula of:
[Si₈(MgₐLi_{b}H_{c})O₂₀(OH)_{4-y}F_{y}]^{z-}.zM⁺
where a ranges from 4.9 to 5.7; b ranges from 0 to 1.05; c ranges from 0 to less than 2; (a+b+c) ranges from 5 to less than 8; y ranges from 0 to less than 4; z=12−2a−b−c; and M is Na or Li; and
forming the precursor slurry comprises:
precipitating a magnesium silicate having the desired value of “a” in the precursor slurry by combining an aqueous solution of a water soluble magnesium salt with an aqueous alkaline solution of one or more sodium compounds in the presence of dissolved silicon-delivering material.

45. The method of claim 44, wherein pH of the alkaline solution ranges from 8 to 12.5 during precipitation.

46. The method of claim 37, wherein the temperature and the pressure of the continuous hydrothermal reaction is from 240° C. to 380° C. and at least 30 bar, respectively.

47. The method of claim 37, wherein the temperature and pressure of the continuous hydrothermal reaction is from 250° C. to 350° C. and at least 40 bar, respectively.

48. The method of claim 37, wherein forming the precursor slurry is performed continuously.

49. The method of claim 37, wherein both the formation of the precursor slurry and the hydrothermal reaction take place simultaneously as a continuous process in the pipe reactor.

50. The method of claim 37, further comprising drying the washed and filtered synthetic magnesium silicate crystals at a temperature of up to 450° C. at normal atmospheric pressure.

51. A synthetic magnesium silicate prepared by a method comprising:
preparing a precursor slurry comprising a magnesium compound and silica;
subjecting the precursor slurry to a continuous hydrothermal reaction in a pipe reactor at a temperature ranging from 210° C. to 400° C. and at a pressure of at least 20 bar for 10 seconds to 4 hours to form the synthetic magnesium silicate, wherein the precursor slurry is not washed and filtered before it is subjected to the continuous hydrothermal reaction; and
washing and filtering the synthetic magnesium silicate to remove water soluble salts formed in the preparation of the precursor slurry.

52. The synthetic magnesium silicate of claim 51, wherein the proportions of magnesium, provided by the magnesium compound, and of silica correspond to that of the formula:
[Si₈(MgₐLi_{b}H_{c})O₂₀(OH)_{4-y}F_{y}]^{z-}.zM⁺
where a ranges from 4.9 to 5.7; b ranges from 0 to 1.05; c ranges from 0 to less than 2;
(a+b+c) ranges from 5 to less than 8; y ranges from 0 to less than 4; z=12−2a−b−c; and M is Na or Li.

53. The synthetic magnesium silicate of claim 51, wherein the magnesium compound comprises magnesium carbonate.

54. The synthetic magnesium silicate of claim 51, wherein forming the precursor slurry comprises forming a silica precipitate by adding the silica to an aqueous suspension of magnesium carbonate.

55. The synthetic magnesium silicate of claim 51, wherein forming the precursor slurry is performed continuously.

56. A synthetic magnesium silicate of a general formula:
[Si₈(MgₐLi_{b}H_{c})O₂₀(OH)_{4-y}F_{y}]^{z-}.zM⁺ where a ranges from 4.9 to 5.7; b ranges from 0 to 1.05; c ranges from 0 to less than 2; (a+b+c) ranges from 5 to less than 8; y ranges from 0 to less than 4; z=12−2a−b−c; and M is Na or Li, prepared by a method, comprising:
precipitating a magnesium silicate having the desired value of “a” in a slurry by combining an aqueous solution of a water soluble magnesium salt with an aqueous alkaline solution of one or more sodium compounds in the presence of dissolved silicon-delivering material, the pH of the alkaline solution being maintained at 8 to 12.5 throughout to form an aqueous slurry;
hydrothermally treating the aqueous slurry in a pipe reactor at a temperature ranging from 210° C. to 400° C. and under a pressure of at least 20 bar for 10 seconds to 4 hours to from synthetic magnesium silicate crystals, wherein the aqueous slurry is not washed and filtered before it is hydrothermally treated; and
washing and filtering the washing and filtering the synthetic magnesium silicate to remove water soluble salts formed in the preparation of the aqueous slurry.
